(19) United States
(12) Patent Application Publication
(10) Pub. No.: US 2017/0314290 A1
(43) Pub. Date: Nov. 2, 2017

(54) Apparatus and method for camouflaging a hunting blind

(71) Applicants: Todd A. Perry, Greenfield, IN (US); Kelly J. Perry, Greenfield, IN (US)

(72) Inventors: Todd A. Perry, Greenfield, IN (US); Kelly J. Perry, Greenfield, IN (US)

(21) Appl. No.: 15/731,177

(22) Filed: Apr. 28, 2017

Related U.S. Application Data
(60) Provisional application No. 62/330,272, filed on May 2, 2016.

(51) Int. Cl. E04H 15/32; A01M 31/02; E04H 15/00; F16M 13/02

(52) U.S. Cl. CPC E04H 15/32; F16M 13/022; A01M 31/025; E04H 15/001

(57) ABSTRACT

The invention is a first body and a second body, the first body includes a first magnetic element such as a coin shaped neodymium magnet, the second body includes a second magnetic element such as a steel disk or a coin shaped neodymium magnet so that the first body can be attracted to the second body by magnetic forces, the first body having an aperture therethrough. A method for custom camouflaging the exterior sheet material of a hunting blind using the apparatus of the instant invention. A method for suspending an article in a hunting blind using the apparatus of the instant invention.

### BACKGROUND OF THE INVENTION

The instant invention relates to blinds used, for example, by hunters, bird watchers and nature photographers. Such blinds can be located on the ground or in a tree or on an elevated platform. Many such blinds comprise an exterior of sheet material supported by a frame of tubing or spring wire or flexible rod. The prior art of hunting blinds comprises a number of means for attaching camouflaging elements to the exterior sheet material of a blind. For example, U.S. Pat. No. 8,066,022 disclosed tube shaped members at hub locations on the exterior of a blind for the insertion of foliage as the camouflaging element. And, U.S. Pat. No. 9,347,237 disclosed different cord members on the exterior of a blind for securing foliage as the camouflaging element, while U.S. Patent Application Publication 2010/0229906 disclosed regularly spaced loops on the exterior of a blind for securing foliage as the camouflaging element. Despite the advances in the art exemplified by the above referenced patents and patent application publications, there remains a need for a means for attaching camouflaging elements to a blind at locations of the exterior sheet material that are customizable by the hunter to suit the specific location of the blind and the specific camouflaging elements available to the hunter.

### SUMMARY OF THE INVENTION

The instant invention is the discovery of a way and apparatus to attach camouflaging elements to a blind at locations of the exterior sheet material of a blind that are customizable by the hunter to suit the specific location of the blind and the specific camouflaging elements available to the hunter. More specifically, in one embodiment the instant invention is apparatus comprising a first body and a second body, the first body comprising a first magnetic element, the second body comprising a second magnetic element so that the first body can be attracted to the second body by magnetic forces, the first body comprising an aperture therethrough. In another embodiment, the instant invention is a method for custom camouflaging the exterior sheet material of a hunting blind, comprising the steps of: (a) positioning a first body comprising a first magnetic element at a selected location on the exterior sheet material of the hunting blind; (b) positioning a second body comprising a second magnetic element on the interior sheet material of the hunting blind adjacent the first body so that the first body is attracted to the second body by magnetic forces with the sheet material of the hunting blind between the first body and the second body; (c) attaching a camouflage element to the first body to camouflage the exterior sheet material of the hunting blind. In yet another embodiment, the instant invention is a method for suspending an article at a custom location in the interior of a hunting blind, the hunting blind comprising exterior sheet material, the method comprising the steps of: (a) positioning a first body comprising a first magnetic element at a selected location on the exterior sheet material of the hunting blind; (b) positioning a second body comprising a second magnetic element on the interior sheet material of the hunting blind adjacent the first body so that the first body is attracted to the second body by magnetic forces with the sheet material of the hunting blind between the first body and the second body; (c) suspending the article from the second body.

### BRIEF DESCRIPTION OF THE DRAWINGS

FIG. 1 is a perspective drawing of a highly preferred embodiment of the instant invention;

FIG. 2 is a perspective drawing of another highly preferred embodiment of the instant invention;

FIG. 3 depicts the embodiment of FIG. 1 in use to provide a tie point on one side of a sheet of material and a point on the other side of the sheet of material for a hook;

FIG. 4 is a perspective view of the exterior sheeting of a hunting blind, partially broken away to show the interior of the blind, wherein a number of the embodiments of shown in FIG. 1 are used to provide customized locations on the blind for the attachment of camouflage elements in the form of tree branches as well as a customized location within the blind for the suspension of a pair of binoculars.

### DETAILED DESCRIPTION OF THE INVENTION

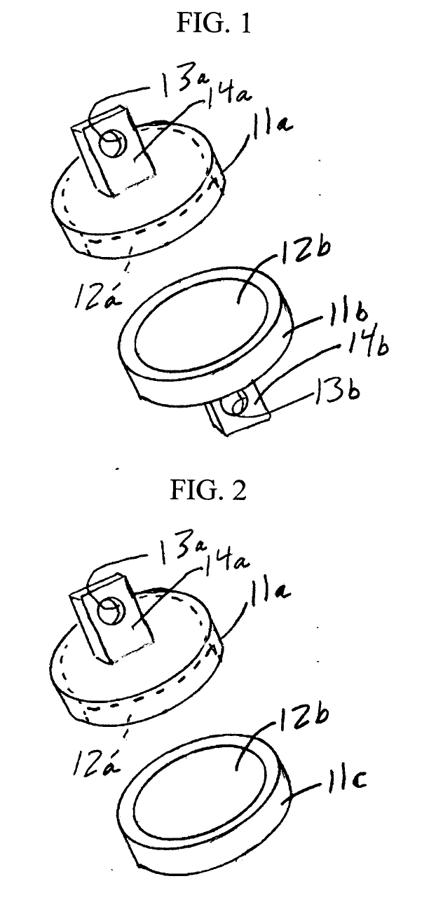

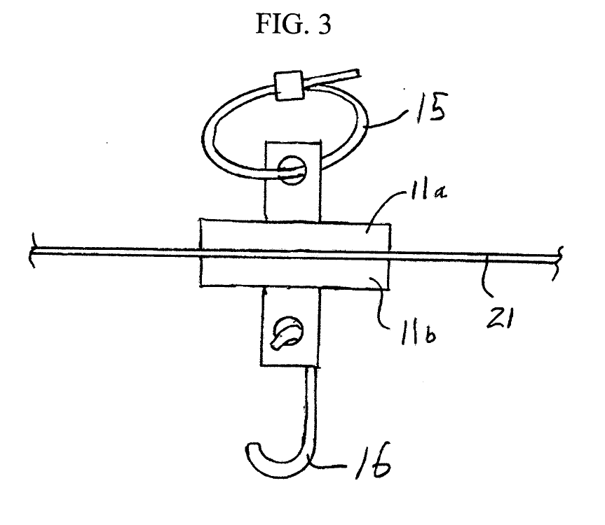

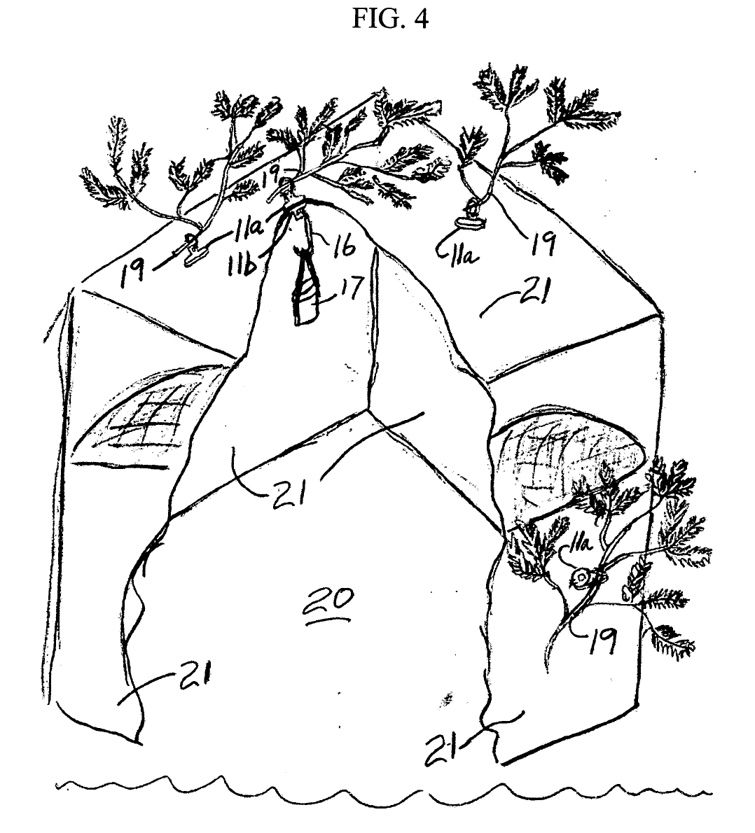

Referring now to FIG. 1, therein is shown a perspective drawing of a highly preferred embodiment of the instant invention comprising first body 11a and second body 11b. First body 11a is formed with a cavity into which is held a coin shaped neodymium magnet 12a. Second body 11b is formed with a cavity into which is held another coin shaped neodymium magnet 12b. The north/south orientation of magnet 12a is complementary to magnet 12b so that first body 11a is attracted to second body 11b by magnetic force. First body 11a comprises flange 14a having aperture 13a therethrough. Second body 11b comprises flange 14b having aperture 13b therethrough. Referring to FIG. 2, therein is shown a perspective drawing of another highly preferred embodiment of the instant invention having the same elements as the embodiment shown in FIG. 1 except that body 11c has no aperture therethrough. Referring now to FIG. 3, therein is shown the embodiment of FIG. 1 in use to provide a tie point for zip tie 15 on one side of a sheet of material 21 and a point on the other side of sheet of material 21 for hook 16. Zip tie 15 is used to attach a camouflage element to body 11a. Hook 16 is used to suspend an article from body 11b such as is shown in FIG. 4.

Referring now to FIG. 4 therein is shown a perspective view of the exterior sheeting 21 of a hunting blind on ground 20, the blind partially broken away to show the interior of the blind. A plurality of bodies 11a paired on the inside by bodies 11b (in the manner detailed in FIG. 3) are used to provide customized locations on the blind for the attachment of camouflage elements 19 in the form of tree branches as well as a customized location within the blind for the suspension of a pair of binoculars 17 by way of hook 16 engaged with the aperture through body 11b.

The components of the apparatus of the instant invention can be made of any suitable material. Preferably, the bodies of the instant invention are made of injection molded plastic. Preferably, the first magnetic element and the second magnetic element are coin shaped neodymium magnets but any magnetic element can be used in the instant invention such as, and without limitation thereto, a coin shaped ferrite magnet. Furthermore, one of the magnetic elements can comprise a metal attracted to a magnet such as a coin shaped blank of steel. And, it should be understood that each body of the instant invention can comprise a plurality of individual magnetic elements. The camouflaging elements for use in the instant invention can be, without limitation thereto, natural or artificial foliage from the location of the blind. The preferred means to tie a camouflaging element to the body of the instant invention is zip tie 3 shown in FIG. 2 but any suitable attachment can be used such as, and without limitation thereto, a clip or a wire twist tie or a cord tie. Similarly, the preferred means of suspending an article such as, and without limitation thereto, binoculars, range finders and kit bags, comprises hook 16 shown in FIGS. 3 and 4.

An important benefit of the instant invention relates to the location of camouflaging elements on the exterior surface of a blind. The instant invention permits the location of camouflaging elements at any desired location. Thus, a hunter or other user of a blind can customize the camouflage to suit the specific location of the blind and to more randomly break up the appearance of the exterior surface of the blind to better camouflage the blind. Because camouflage elements are often harvested from natural foliage found at the location of the blind and since the size and shape of natural foliage is not uniform, the instant invention provides a way to arrange such natural foliage of the blind in a manner that accommodates the variation in the size and shape of the foliage.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. Apparatus comprising a first body and a second body, the first body comprising a first magnetic element, the second body comprising a second magnetic element so that the first body can be attracted to the second body by magnetic forces, the first body comprising an aperture therethrough.

2. The apparatus of claim 1, wherein the second body comprises an aperture therethrough.

3. The apparatus of claim 1, wherein the first magnetic element is a composition comprising iron and the second magnetic element is a magnet.

4. The apparatus of claim 2, wherein the first magnetic element is a composition comprising iron and the second magnetic element is a magnet.

5. The apparatus of claim 1, wherein the first magnetic element is a magnet and the second magnetic element is a magnet.

6. The apparatus of claim 2, wherein the first magnetic element is a magnet and the second magnetic element is a magnet.

7. The apparatus of claim 1, wherein the first magnetic element is a coin shaped neodymium magnet and the second magnetic element is a coin shaped neodymium magnet.

8. The apparatus of claim 1, wherein the first magnetic element is a coin shaped neodymium magnet and the second magnetic element is a coin shaped neodymium magnet.

9. A method for custom camouflaging the exterior sheet material of a hunting blind, comprising the steps of: (a) positioning a first body comprising a first magnetic element at a selected location on the exterior sheet material of the hunting blind; (b) positioning a second body comprising a second magnetic element on the interior sheet material of the hunting blind adjacent the first body so that the first body is attracted to the second body by magnetic forces with the sheet material of the hunting blind between the first body and the second body; (c) attaching a camouflage element to the first body to camouflage the exterior sheet material of the hunting blind.

10. The method of claim 9, wherein the camouflage element is foliage.

11. The method of claim 9, wherein steps (a)-(c) are repeated to better camouflage the exterior sheet material of the hunting blind.

12. The method of claim 10, wherein steps (a)-(c) are repeated to better camouflage the exterior sheet material of the hunting blind.

13. A method for suspending an article at a custom location in the interior of a hunting blind, the hunting blind comprising exterior sheet material, the method comprising the steps of: (a) positioning a first body comprising a first magnetic element at a selected location on the exterior sheet material of the hunting blind; (b) positioning a second body comprising a second magnetic element on the interior sheet material of the hunting blind adjacent the first body so that the first body is attracted to the second body by magnetic forces with the sheet material of the hunting blind between the first body and the second body; (c) suspending the article from the second body.

14. The method of claim 13, wherein the second body comprises an aperture therethrough so that a hook positioned through the aperture can be used between the second body and the suspended article.

15. The method of claim 14, wherein the first body comprises an aperture therethrough so that a camouflage element can be tied to the first body by way of the aperture through the first body.
